(19) United States
(12) Patent Application Publication
(10) Pub. No.: US 2024/0059257 A1
(43) Pub. Date: Feb. 22, 2024

(54) Cart For Cleaning Trailer Outer Surfaces

(71) Applicant: Sargento Foods Inc., Plymouth, WI (US)

(72) Inventor: Timothy W. Meyer, New Holstein, WI (US)

(21) Appl. No.: 17/889,321

(22) Filed: Aug. 16, 2022

(51) Int. Cl. B60S 3/04; A46B 15/00

(52) U.S. Cl. CPC B60S 3/045; A46B 15/0055; A46B 2200/30

(57) ABSTRACT

A manually moveable cart for cleaning an outer surface of a trailer, the cart including a frame, plurality of stair treads, a lower handrail, an upper handrail, a lower platform, an upper platform, a single brush, and wheels.

### FIELD OF THE INVENTION

The present subject matter relates to a cart for cleaning trailers, and more particularly, to a moveable cart with a brush mounted thereon for cleaning the outer surfaces of trailers.

### BACKGROUND OF THE INVENTION

The outer walls and surfaces of trailers, such as tractor trailers, need to be cleaned periodically. Often the cleaning involves manual labor in that workers are on ladders with brushes to clean the trailer. This is a time-consuming process that can lead to worker fatigue and injury.

### SUMMARY OF THE INVENTION

In one construction, the disclosure provides a cart for cleaning an outer wall of a trailer. The cart includes a frame generally a same height from the ground as an outer wall of a trailer to be cleaned, a plurality of stair treads secured to the frame, a platform adjacent an upper most stair tread, a single brush secured to the frame in a vertical orientation and adapted to be the only point of contact with the trailer, wheels secured to the frame for manually movement of the cart, and a handrail to enable the manual movement of the cart.

In another construction, the disclosure provides a cart for cleaning an outer surface of a trailer. The cart includes a frame generally a same height from the ground as an outer surface of a trailer to be cleaned, the frame including a plurality of horizontal, vertical and angled support members, a single brush secured to at least one of the plurality of support members and adapted to be the only point of contact with the trailer, wheels secured to the frame for manually moving the cart along the trailer, and a handrail secured to the frame to enable the manual movement of the cart.

Other aspects of the disclosure will become apparent by consideration of the detailed description and accompanying drawings.

### BRIEF DESCRIPTION OF THE DRAWINGS

FIG. 1 is a front view of the invention.

FIG. 2 is a side view of the invention.

FIG. 3 is a perspective view of the invention aside an outer surface of a tractor trailer.

### DETAILED DESCRIPTION

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways.

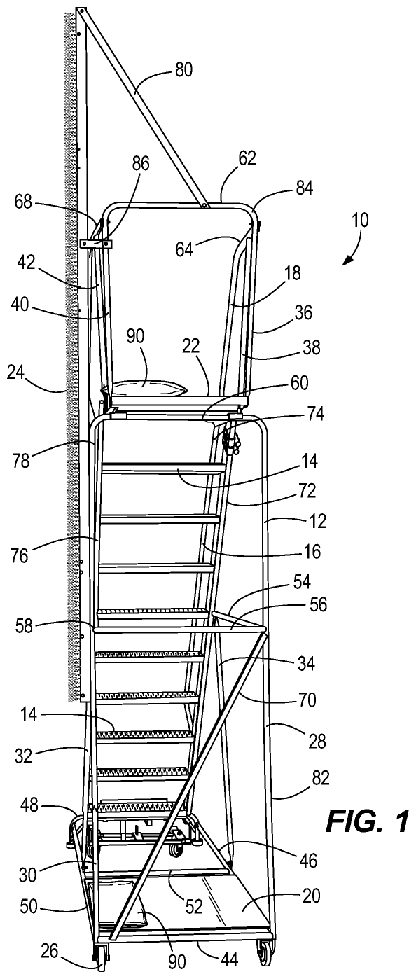

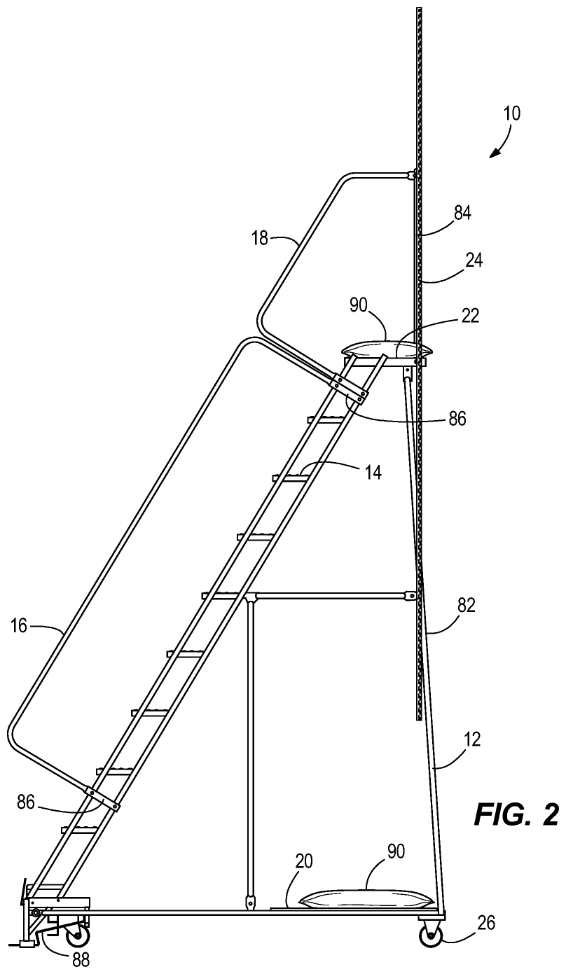

With reference to FIGS. 1 and 2, there is shown a cart 10 for cleaning the outer walls and surfaces of a trailer. The cart 10 is generally known in the art as a ten-step type rolling ladder. The cart 10 includes a frame 12, a plurality of stair treads 14, a lower handrail 16, an upper handrail 18, a lower platform 20, an upper platform 22, a single brush 24, and wheels 26. The cart includes only mechanical components with no electrical components.

The frame 12 has a triangular shape as viewed from the side although other geometries can also be utilized. As shown in FIG. 1, the frame 12 includes a plurality of support members such as vertical supports 28, 30, 32, 34, 36, 38, 40 and 42, horizontal supports 44, 46, 48, 50, 52, 54, 56, 58, 60, 62, 64, 66 and 68, and angled supports 70, 72, 74, 76, 78 and 80. The supports can be fabricated of various materials such as metal and plastic. The frame 12 includes a lower portion 82 and an upper portion 84. The frame 12 is generally the same height from the ground as the outer surface of the trailer surface to be cleaned.

The stair treads 14 have a run along the hypotenuse of the triangular shape of the frame 12 and are secured to the frame 12 as is known in the art. The stair treads 14 enable a worker to ascend to and from the upper platform 22.

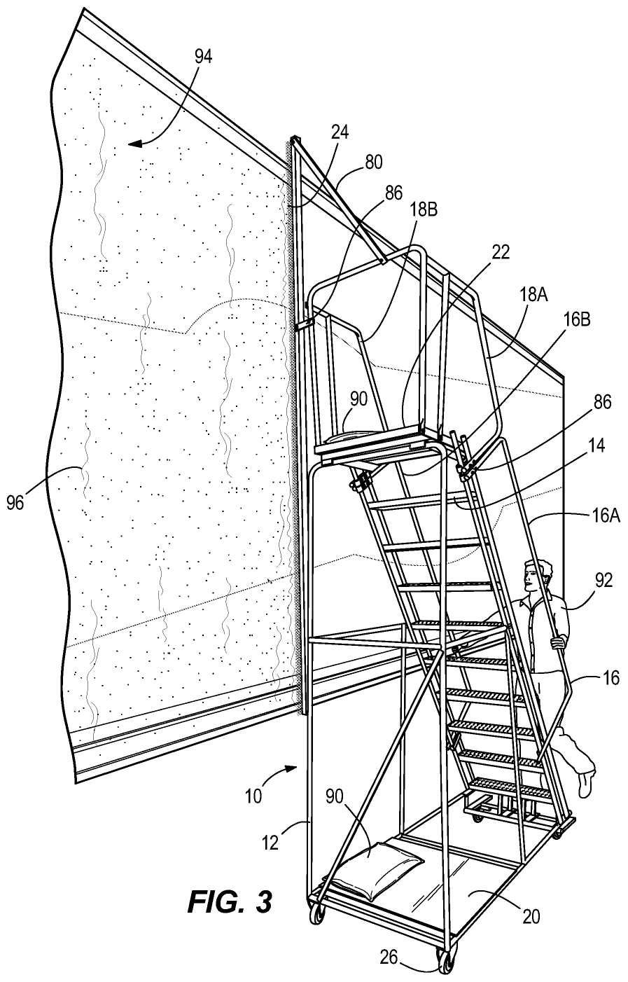

The lower handrail 16 serves the dual purpose as a safety guide when a worker is ascending or descending the stair treads 14 and as surface to grip by a worker to manually move the cart 10. Preferably, there is a first lower handrail 16A and a second lower handrail 16B (as shown in FIG. 3) that are parallel. The lower handrails 16 are secured to the angled support 72 and/or 74 or angled supports 76 and/or 78 such as with brackets 86, however, other fasteners can also be utilized.

The upper handrail 18 serves as safety guide when a worker is ascending or descending the stair treads 14. Preferably, there is a first upper handrail 18A and a second upper handrail 18B (as shown in FIG. 3) that are parallel. The upper handrail 18 is secured to the angled support 72, 74, 76 or 78 and vertical support 36 or 40 such as with a bracket 86.

The lower platform 20 is positioned in the lower portion 82 of the frame 12. The lower platform 20 can be fabricated of any desired material such as wood, plastic and the like.

The upper platform 22 is positioned in the upper portion 84 of the frame 12 adjacent the upper most stair tread 14. The upper platform 22 provides a surface upon which a worker can stand. The upper platform 22 can be fabricated of any desired material such as wood, plastic and the like.

The single brush 24 is mounted to the cart 12 to be in a generally vertical orientation and is not movable relative to the frame 12. Preferably, the brush 24 is approximately the same height as the surface or the wall of the trailer to be cleaned. The brush 24 can be of a varying type as is known in the art, for example a 24″ professional soft green Nyltex bristle brush available from Fastenal, however other brushes can be utilized. The brush 24 is mounted to the frame 12 using a suitable fastener such as brackets 86. The brush 24 is secured to the frame 12 along the vertical supports 28 and 36 and the diagonal support 80. The brush 24 is the only point of contact of the cart 10 with the trailer such that the frame 12 supports the weight of the cart 12.

The wheels 26 are secured to the frame 12 so as to enable the cart 12 to be manually moved by a worker, such as by pushing and pulling, where necessary. Preferably, the wheels 26 are castor wheels as is known in the art. Optionally, one or more wheels 26 may include a brake mechanism 88 (as best shown in FIG. 2) for preventing unintended movement of the cart 12.

Optionally, the cart 12 may include fixed or removable ballast 90 to prevent the cart 12 from tipping. The ballast 90 can include any weighted materials such as the bag of sand and can be placed or positioned such as on the lower platform 22 shown in FIG. 3. Ballast 90 can be placed or positioned anywhere on the cart 12 including the upper platform 22 and can include varying weights such as 100 pounds for example.

The cart 10 of the present invention can be utilized to clean the outer walls and surfaces of many types of trailers. The term trailer can include tractor trailers, campers, recreational vehicles, tall stationary structures, tall moveable items, and the like.

With reference to FIG. 3, in operation, a worker 92 uses the lower handrails 16A and 16B to move the cart 12 adjacent an outer surface 94 of a trailer to be cleaned. The worker 92 positions the cart 12 so that the brush 24 is in contact with the surface 94. The worker 92 then uses the lower handles 16A and 16B to manually push the cart 12 parallel to the outer surface 94 so that the brush 24 contacts and cleans the surface 94 as it is moved along the surface 94 by the worker 92. As shown in FIG. 3, a cleaning solution 96 such as water with detergent has been previously applied to the surface 94, however, a cleaning solution 96 is not necessary for operation of the cart 12 and the cart 12 can thus be utilized without a cleaning solution 96.

Various features and advantages of the invention are set forth in the following claims.

What is claimed is:

1. A cart for cleaning an outer wall of a trailer comprising:
a frame generally a same height from the ground as an outer wall of a trailer to be cleaned;
a plurality of stair treads secured to the frame;
a platform adjacent an upper most stair tread;
a single brush secured to the frame in a vertical orientation and adapted to be the only point of contact with the trailer;
wheels secured to the frame for manually movement of the cart; and
a handrail to enable the manual movement of the cart.

2. The cart of claim 1 and further including a second platform adjacent the wheels.

3. The cart of claim 2 and further including one of a fixed and a removable ballast on the second platform.

4. The cart of claim 1 and further including one of a fixed and a removable ballast on the platform.

5. The cart of claim 1 wherein the brush is a 24″ professional soft green Nyltex bristle brush.

6. The cart of claim 1 wherein the handrail is adjacent the stair treads.

7. The cart of claim 6 wherein the handrail extends generally the run of the stair treads.

8. The cart of claim and further including a wheel brake engageable with at least one wheel to restrict movement of the cart.

9. The cart of claim 1 wherein the frame supports the weight of cart.

10. The cart of claim 1 where the frame is generally a triangular shape.

11. The cart of claim 10 wherein the brush is secured to one a vertical leg of the triangular shape.

12. The cart of claim 1 and having only mechanical components.

13. The cart of claim 10 wherein the stair treads are aligned with a hypotenuse of the triangular shape.

14. The cart of claim 1 wherein the brush does not move relative to the frame.

15. A cart for cleaning an outer surface of a trailer comprising:
a frame generally a same height from the ground as an outer surface of a trailer to be cleaned, the frame including a plurality of horizontal, vertical and angled support members;
a single brush secured to at least one of the plurality of support members and adapted to be the only point of contact with the trailer;
wheels secured to the frame for manually moving the cart along the trailer; and
a handrail secured to the frame to enable the manual movement of the cart.

16. The cart of claim 15 and further including a plurality of stair treads secured to the frame.

17. The cart of claim 15 and further including one of a fixed and a removable ballast to prevent tipping of the cart.

18. The cart of claim 15 wherein the brush does not move relative to the frame.

19. The cart of claim 15 and further including an upper and a lower platform secured to the frame.

20. The cart of claim 15 wherein the frame is of a triangular geometry.
